(19) United States
(12) Patent Application Publication
(10) Pub. No.: US 2010/0265582 A1
(43) Pub. Date: Oct. 21, 2010

(54) Optical isolators

(76) Inventor: HUI DU, Toronto (CA)

Correspondence Address: HUI DU, Apt. 908, 30 Carabob Court, Toronto, ON, M1T 3N2, CA

(21) Appl. No.: 12/799,692

(22) Filed: Mar. 18, 2009

(51) Int. Cl. G02B 5/30

(52) U.S. Cl. 359/494

(57) ABSTRACT

Optical isolators are important for optical communication systems and serve to reduce the unwanted reflection from the connectors and components in the output side. Conventional optical isolators have two polarizers and a Faraday rotator. The present invention provides simplified isolators which can achieve the optical isolation function.

### FIELD OF THE INVENTION

This invention relates to optical isolators for optical fiber communication systems and optical instrument.

### BACKGROUND OF THE INVENTION

Laser diode is the key transmitter device in optical communication systems, which translate electronic signals into optical signals. With the rapid increase of information demand, it is desirable to increase the transmittance speed. In another word, more information is expected in a single fiber than before, and thus the laser diode should work at a higher transmittance rate. However, it is clear that the higher of the laser speed, the more the backward reflection light will affect the stability of laser diode. Generally speaking, there must be an optical isolator to eliminate the disturbance of the return light when the speed of optical signal speed is lager than 2.5 G/s. Nowadays, the speed of a single wavelength is 10 G/s and even 40 G/s in telecommunication and internet backbone networks. Moreover, with the rapid development of FTTH (Fiber To The Home), there will be a huge demand for high speed laser devices, and thus the optical isolators.

As shown in FIG. 1, traditional polarization dependent optical isolators 10 are composed of three parts. A first polarizer 11 and a second polarizer 13 in which a Faraday rotator 12 is sandwiched between, are arranged to make the angle between polarization axis of first polarizer 11 and polarization axis of said second polarizer 13 to be 45°. The incident polarization beam 14a is aligned to the first polarizer 11 almost without any loss of light energy. Then the beam 14b goes through Faraday rotator 12 which gives the beam a 45° rotation. Afterwards the light 14c goes through the second polarizer 13 transparently since it has an arrangement of 45° axis angle difference with that of first polarizer 11. For the backward direction, the reflected beam 15a goes through the second polarizer 13 and become beam 15b. Then beam 15b is rotated 45° again by the Faraday rotator 12 in the same direction with the first 45° rotation, because the Faraday rotator will rotate the beam in the same direction no matter which direction the beam is traveling. Therefore, the polarization direction of the reflected light 15c is perpendicular to the optical axis of the first polarizer 11, and thus the backward light 15c was totally cut off.

There is another type of optical isolators without the need of control of the polarization. Such isolators are commonly called polarization independent isolators 20. Refer to FIG. 2A, 2B, where there is shown a non polarized light beam 21 incident on a first wedge birefringent crystal 22 . The light beam 21 is split into an ordinary beam 210 and an extraordinary beam 21e, and allowed to pass through a Faraday rotor 23 and a second wedge birefringent crystal 24. Polarization of the ordinary beam 210 and the extraordinary beam 21e are both rotated 45° by the Faraday rotator 23. When ordinary beam 210 and the extraordinary beam 21e go through the second wedge birefringent crystal 24, they keep to be still ordinary and extraordinary beam respectively, since the second wedge birefringent crystal 24 is selected to have his axis an 45° angle with that of the first wedge birefringent crystal 22. The reflected beams 21r (see FIG. 2B) of these two beams will enter the Faraday rotator 23 and each get additional 45° rotation in the same direction. Therefore, the total angle of rotation is 90° for both beams. When these beams pass through the first wedge crystal 22, the original ordinary beam 21ro will become an extraordinary beam whereas the original extraordinary beam 21re will become an ordinary beam. Therefore, both 21e and 21r″ beams will be directed in directions different from the input light beam 21.

Although the traditional isolators as described above will block all polarization mode of the return light from the optical system, it is noted that the main part of the return light is due to the near end reflection, which has the same polarization direction with the output beam 14d as shown in FIG. 1. According to this invention, an optical isolator without the second polarizer or wedge birefringent crystal is provided in order to reduce cost of manufacturing.

### OBJECTS OF THE INVENTION

One object of this invention is to provide a simplified optical isolator structure based on a Faraday rotator. The other object is to provide a simplified optical isolator structure based on a quarter-wave plate.

### DESCRIPTION OF THE DRAWINGS

FIG. 1 is a schematic diagram showing the structure of the traditional polarization dependent optical isolators.

FIG. 2 is (a) a schematic diagram of a conventional polarization independent optical isolator showing the inputs, and (b) a schematic diagram showing the reflected beams.

FIG. 3 shows the structure of a polarization dependent optical isolator with one linear polarizer and one Faraday rotator according to this invention.

FIG. 4 is a schematic diagram showing another polarization dependent optical isolator with one linear polarizer and one quarter-wave plate according to this invention.

FIGS. 5A, 5B show schematic diagrams of polarization independent optical isolators with a wedge birefringent crystal and one Faraday rotator according to this invention.

FIG. 6A, 6B is the schematic diagram of another polarization independent optical isolator with a wedge birefringent crystal and one quarter-wave plate according to this invention.

FIG. 7 is the schematic diagram of simplified optical isolators with integrated pigtails and collimators according to this invention.

### DETAILED DESCRIPTION OF THE INVENTION

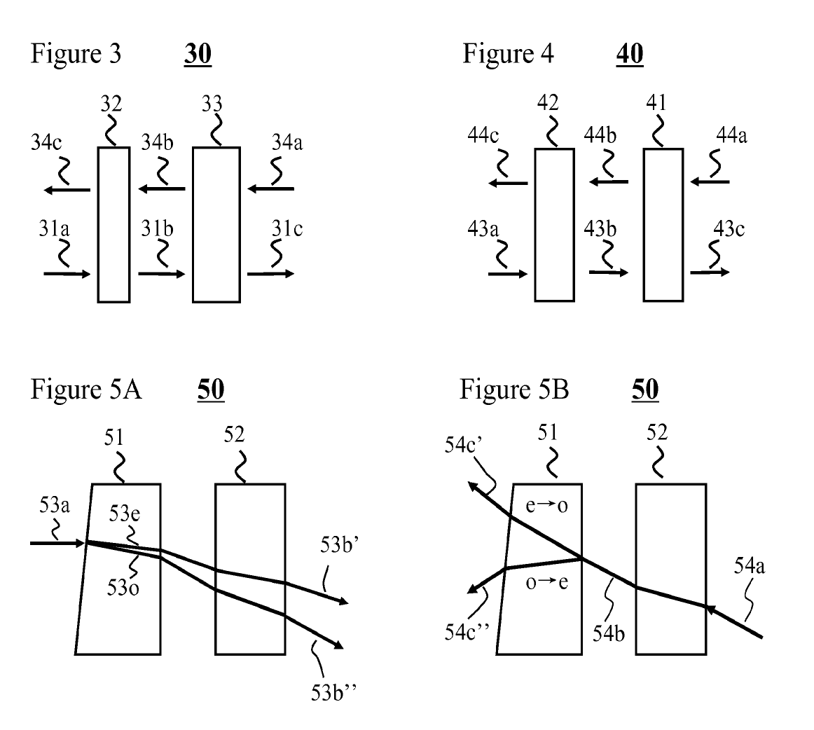

One embodiment of the present invention of a polarization dependent optical isolator 30 is shown in FIG. 3. The incident linear polarization beam 31a goes through the first polarizer 32 with alignment , and then passes through the rotator 33 with an 45° rotation in polarization. Parts of the output beam 31c will be reflected by output interface (not shown) and forming a reflected beam 34a. In this fashion, this reflected beam 34a goes back into Faraday rotator 33 and get a polarization angle change of 45° again. Therefore the light beam 34b is eventually perpendicular to the optical axis of polarizer 32 and totally blocked. Hence, the final reflected beam 34c is very small compared to 31a. The optical isolation performance of the optical isolators in FIG. 3 is almost as good as the conventional optical isolators with two polarizers. It is thus evident from the above description that the invention according to FIG. 3 has the advantage of eliminating the second polarizer 13 as depicted in FIG. 1 for conventional optical isolators. Therefore, the manufacturing cost of the simplified optical isolators shown in FIG. 3 according to this invention can be reduced significantly.

Another embodiment to be provided is a polarization dependent optical isolator 40 without the Faraday isolator. Here, the Faraday isolator 33 shown in FIG. 3 is replaced by a quarter-wave plate 41 as shown in FIG. 4. Said quarter-wave plate is combined with a first polarizer 42 and arranged in such a way that polarization axis of 42 and optical axis of 41 make an angle of 45°. The incident linear polarization beam 43a is aligned to go through the first polarizer 42, and then though the quarter-wave plate 41 to get a circularized polarization of light beam 43c to the output interface (not shown). Parts of the output beam 43c will be reflected by output interface (not shown) and forming a reflected beam 44a. In this fashion, this reflected beam 44a goes back into quarter-wave plate 41 and get a linear polarization beam 44b with a polarization angle change of 90° with respect to the incident light beam 43a. Therefore the light beam 44b is eventually perpendicular to the optical axis of polarizer 42 and totally blocked . Hence, the final reflected beam 44c is very small compared to 43a. The optical isolation performance of the optical isolators in FIG. 4 is almost as good as the conventional optical isolators with two polarizers and a Faraday rotator. It is thus evident from the above description that the invention according to FIG. 4 has the advantage of eliminating not only the second polarizer 13 but the Faraday rotator 12 as depicted in FIG. 1 for conventional optical isolators. Therefore, the manufacturing cost of the simplified optical isolators shown in FIG. 4 according to this invention can be reduced significantly.

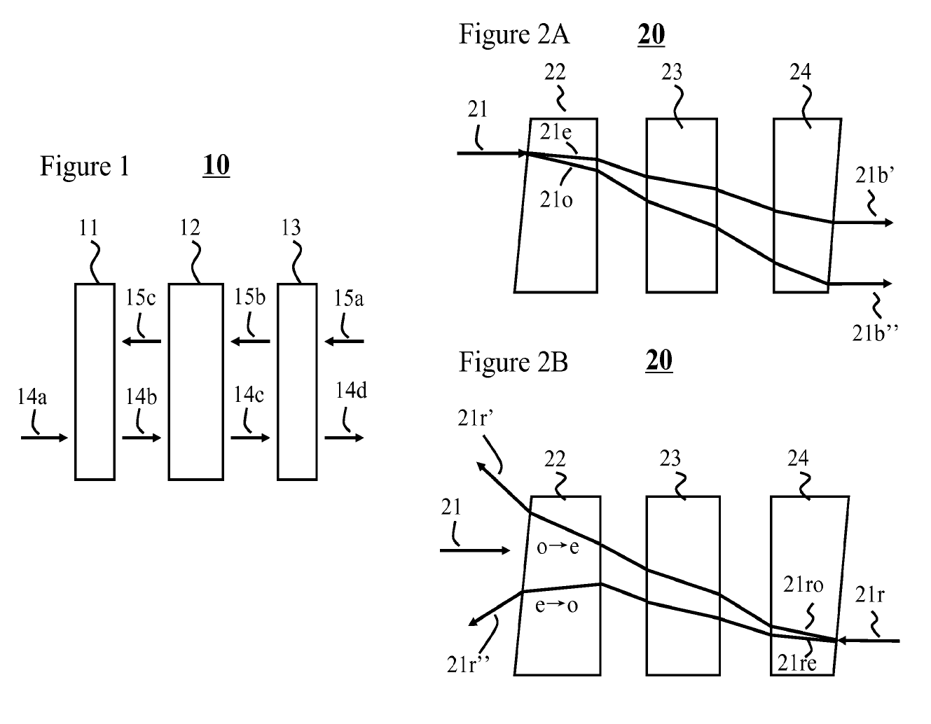

Although FIGS. 3 and 4 show new simplified structures of optical isolators, these arc for polarized light beams. It is necessary to provide new simplified optical isolator structures for polarization independent operation. FIGS. 5A and 5B show one new invention embodiment of the polarization independent optical isolator 50 according to this invention. In FIG. 5, a first wedge birefringent crystal 51 is combined with a Faraday rotator 52 to form a simplified polarization independent optical isolator. The incident beam 53a, which could be any kinds of polarization mode, is input to wedge birefringent crystal 51 and get an ordinary light beam 53o and an extraordinary light beam 53e. Then the ordinary light beam 53o and the extraordinary light beam 53e are rotated 45° by the Faraday rotator 52 respectively and form the output light beams 53b′, 53b″. Parts of the output beam 53b′, 53b″ will be reflected by output interface (not shown) and forming a reflected beam 54a as depicted in FIG. 5B. In this fashion, this reflected beam 54a goes back into the Faraday rotator 52 and get a polarization rotation of 45° again, making the total angle change of 90° with respect to the incident light beam 53a. Therefore the light beam 54b will undergo an exchange from ordinary to extraordinary and from extraordinary to ordinary when passing through the wedge birefringent crystal 51. Thus, the final reflected beams 54c′, 54c″ will be in directions different from the original input light beam 53a and will not be coupled into the optical light source (not shown). It is thus evident from the above description that the invention according to FIG. 5A, 5B has the advantage of eliminating the second wedge birefringent crystal 24 as depicted in FIG. 2 for conventional polarization independent optical isolators. Therefore, the manufacturing cost of the simplified optical isolators shown in FIG. 5A and 5B according to this invention can be reduced significantly.

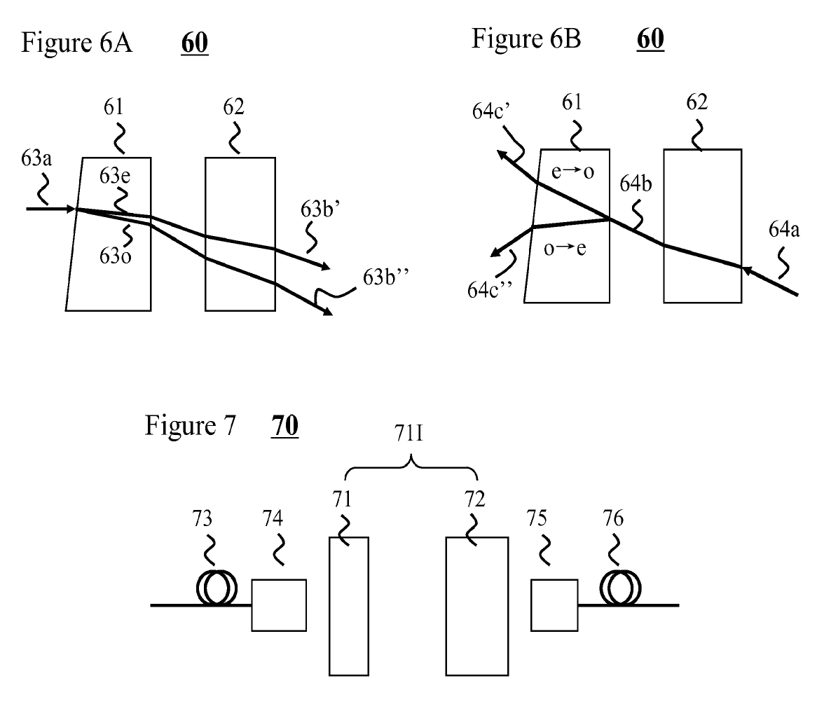

Another embodiment according to this invention is a polarization independent isolator 60 as shown in FIG. 6. A first wedge birefringent crystal 61 is combined with a quarter-wave plat 62 to form a simplified polarization independent optical isolator. The optical axis of said quarter-wave plate 62 is selected to be a 45° of angle with that of the first wedge birefringent crystal 61.The incident beam 63a, which could be any kinds of polarization mode, is input to wedge birefringent crystal 61 and get an ordinary light beam 63o and an extraordinary light beam 63e. After passing through the quarter-wave plate 62, these light beams 63o, 63e will become circularly polarized beams, 63b′, 63b″. Parts of the output beam 63b′, 63b″ will be reflected by output interface (not shown) and forming a reflected beam 64a as depicted in FIG. 6B. In this fashion, this reflected beam 64a goes back into the quarter-wave plate 62 and become linearly polarized light beam with polarization angle change of 90°. Therefore the light beam 64b will undergo an exchange from ordinary to extraordinary and from extraordinary to ordinary when passing through the wedge birefringnent crystal 61. Thus, the final reflected beams 64c′, 64c″ will be in directions different from the original input light beam 63a and will not be coupled into the optical light source (not shown). It is thus evident from the above description that the invention according to FIG. 6A, 6B has the advantage of eliminating not only the second wedge birefringent crystal 24 but the Faraday rotator 23 as depicted in FIG. 2 for conventional polarization independent optical isolators. Therefore, the manufacturing cost of the simplified optical isolators shown in FIG. 6A, 6B according to this invention can be reduced significantly.

According to still another embodiment of this invention, the simplified optical isolators may be combined conveniently with pigtails of optical fibers and collimators, which could be any kinds of focusing lens including ball lens, asperical lens and grin lens, to form inline optical isolators 70 as shown in FIG. 7. Here, 71I is a simplified polarization dependent isolator according to this invention, a first fiber pigtail 73 is connected to a first collimator 74 to form input optical unit. Light beam from the input optical unit will be allowed to pass through the 71I and reach a second collimator 75, which is connected to a second pigtail fiber 76. In this manner, the simplified polarization dependent isolators may be conveniently used to form into an inline optical isolator. The simplified polarization dependent isolators include the ones described in FIG. 3 and FIG. 4. To those skilled in the arts, it is clear that the inline optical isolator may be constructed using the simplified polarization independent optical isolators as provided in this invention. The simplified polarization independent isolators include the ones described in FIG. 5 and FIG. 6.

What is claimed is:

1. An optical isolator comprising;
a first polarizer, and
a means to rotate polarization of incident light beam for the minimization of unwanted reflection of said light beam to a light source.

2. An optical isolator as defined in claim 1, wherein said means to rotate polarization of incident light beam is selected so that angle of rotation of polarized light through said means is 45°.

3. An optical isolator as defined in claim 1, further comprising a first means to couple light from a light source, said first means to couple light being selected from a group of: optical fibers, integrated waveguides, a collimator and their combinations.

4. An optical isolator as defined in claim 1, further comprising a second means to couple light to an output interface, said second means to couple light being selected from a group of: optical fibers, integrated waveguides, a collimator and their combinations.

5. An optical isolator as defined in claim 1, further comprising a anti-reflective layer on said a first polarizer and on said the means to rotate polarization angle of incident light to minimize un-wanted reflection from surfaces.

6. An optical isolator comprising;
a first polarizer, and
a quarter-wave plate for the minimization of unwanted reflection of said light beam to a light source.

7. An optical isolator as defined in claim 6, wherein axis of said a quarter-wave plate is selected to be a 45° angle with that of said a first polarizer.

8. An optical isolator as defined in claim 6, further comprising a first means to couple light from a light source, said first means to couple light being selected from a group of: optical fibers, integrated waveguides, a collimator and their combinations.

9. An optical isolator as defined in claim 6, further comprising a second means to couple light to an output interface, said second means to couple light being selected from a group of: optical fibers, integrated waveguides, a collimator and their combinations.

10. An optical isolator as defined in claim 6, further comprising a anti-reflective layer on said a first polarizer and on said the means to rotate polarization angle of incident light to minimize un-wanted reflection from surfaces.

11. An optical isolator comprising;
a wedge birefringent crystal, and
a means to rotate polarization of incident light beam for minimizing unwanted reflection of light to said light source.

12. An optical isolator as defined in claim 11, wherein said means to rotate polarization of incident light beam is selected so that angle of rotation of polarized light through said means to rotate polarization of incident light beam is 45°.

13. An optical isolator as defined in claim 11, further comprising a first means to couple light from a light source, said first means to couple light being selected from a group of: optical fibers, integrated waveguides, a collimator and their combinations.

14. An optical isolator as defined in claim 11, further comprising a second means to couple light to an output interface, said second means to couple light being selected from a group of: optical fibers, integrated waveguides, a collimator and their combinations.

15. An optical isolator as defined in claim 11, further comprising an anti-reflective layer on said a wedge birefringent crystal and on said the means to rotate polarization angle of incident light, to minimize un-wanted reflection from surfaces.

16. An optical isolator comprising;
a wedge birefringent crystal, and
a quarter-wave plate for minimizing unwanted reflection of light to said light source.

17. An optical isolator as defined in claim 16, wherein axis of said a quarter-wave plate is selected to be a 45° angle with that of said a wedge birefringent crystal.

18. An optical isolator as defined in claim 16, further comprising a first means to couple light from a light source, said first means to couple light being selected from a group of: optical fibers, integrated waveguides, a collimator and their combinations.

19. An optical isolator as defined in claim 16, further comprising a second means to couple light to an output interface, said second means to couple light being selected from a group of: optical fibers, integrated waveguides, a collimator and their combinations.

20. An optical isolator as defined in claim 16, further comprising an anti-reflective layer on said a wedge birefringent crystal and on said the means to rotate polarization angle of incident light, to minimize un-wanted reflection from surfaces.
